(19) United States
(12) Patent Application Publication
(10) Pub. No.: US 2007/0033617 A1
(43) Pub. Date: Feb. 8, 2007

(54) Redirecting broadcast signals for recording programming

(75) Inventor: L. Scott Bloebaum, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: Sony Ericsson Mobile Communications AB, Lund (SE)

(21) Appl. No.: 11/161,574

(22) Filed: Aug. 8, 2005

(51) Int. Cl. H04N 7/16; G06F 3/00; G06F 13/00; H04N 7/173; H04N 5/445

(52) U.S. Cl. 725/58; 725/134; 725/142

(57) ABSTRACT

A method, system, communications device and computer program product for redirecting broadcast signals for recording programming may include detecting occurrence of a predetermined condition or event. The method, system, communications device and computer program product may also include transmitting a message to redirect the broadcast signals for recording the programming carried by the broadcast signals. The method, system, communications device and computer program product may further include transmitting any options or instructions associated with redirecting the broadcast signals or recording the programming.

### BACKGROUND OF THE INVENTION

The present invention relates to communications devices and systems, and more particularly to a communications device, system and method to redirect broadcast signals for recording programming for later viewing.

Communications devices are becoming more sophisticated and including many new features and capabilities. One such feature is the capability to receive mobile broadcast signals or mobile television or the like, such as digital video broadcast-handheld (DVB-H), digital media broadcast (DMB), integrated services digital broadcast-terrestrial (ISDB-T) or similar technologies. There are circumstances when a user has to shut-off such a communications device either by choice or by accident. This will result in interrupting reception of mobile broadcast signals being received by the communications device. For example, the user may be going through security at an airport and is being required to shut down his or her communications device on which the user is viewing some important programming, or the power source or battery on the communications device is nearly fully dissipated and about to shut-off. In these cases, the user may be watching a very important program that he or she does not want to miss, such as a championship sporting event, movie or other programming that will be missed.

### BRIEF SUMMARY OF THE INVENTION

In accordance with an embodiment of the present invention, a method for redirecting broadcast signals for recording may include detecting occurrence of a predetermined condition or event. The method may also include transmitting a message to redirect the broadcast signals for recording programming carried by the broadcast signals. The method may further include transmitting any options or instructions associated with redirecting the broadcast signals or recording the programming.

In accordance with another embodiment of the present invention, a method for redirecting broadcast signals for recording may include recording programming in response to receiving a message to start recording programming carried by the broadcast signals and according to any options or instructions. The message to start recording programming may be sent in response to detecting occurrence of a predetermined condition or event in a communications device. The method may also include transmitting broadcast signals of the recorded programming in response to receiving a signal or message to transmit the recorded programming. The signal or message to transmit the recorded programming may be sent in response to a change in the predetermined condition or event. The method may further include continuing to record any portions of the programming according to any options or instructions.

In accordance with another embodiment of the present invention, a system for redirecting broadcast signals for recording may include a recorder to record programming in response to receiving a message to start recording programming carried by the broadcast signals and to record the programming according to any options or instructions. The message to start recording programming may be sent by a communications device in response to detecting occurrence of a predetermined condition or event. The system may also include a transceiver to broadcast signals of the recorded programming in response to receiving a signal or message to transmit the recorded programming. The signal to transmit the recorded programming may be sent by the communications device in response to a change in the predetermined condition or event.

In accordance with another embodiment of the present invention, a communications device may include a feature adapted to generate a message to redirect broadcast signals for recording the programming carried by the broadcast signals in response to detecting occurrence of a predetermined condition or event. The communications device may also include a transmitter to transmit the message to redirect the broadcast signals and any options or instructions associated with redirecting the broadcast signals or recording the programming.

In accordance with another embodiment of the present invention, a computer program product for redirecting broadcast signals for recording may include a computer readable medium having computer usable program code embodied therein. The computer readable medium may include computer usable program code configured to detect occurrence of a predetermined condition or event. The computer program product may also include computer usable program code configured to transmit a message to redirect the broadcast signals for recording programming carried by the broadcast signals. The computer program product may further include computer usable program code configured to transmit any options or instructions associated with redirecting the broadcast signals or recording the programming.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A, 1B and 1C (collectively FIG. 1) are a flow chart of an example of a method for redirecting broadcast signals for recording in accordance with an embodiment of the present invention.

FIG. 2 is a flow chart of an example of a method for redirecting broadcast signals for recording in accordance with another embodiment of the present invention

FIGS. 3A, 3B and 3C (collectively FIG. 3) are a block schematic diagram of an exemplary system and communications device for redirecting broadcast signals for recording in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

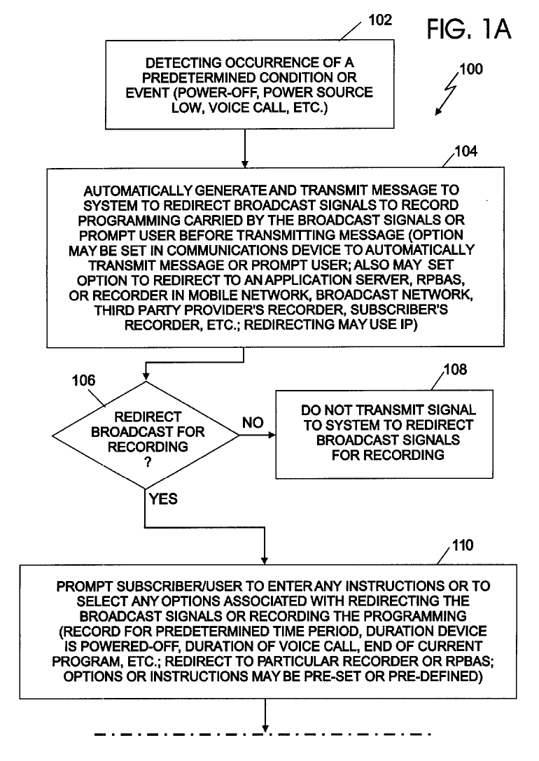

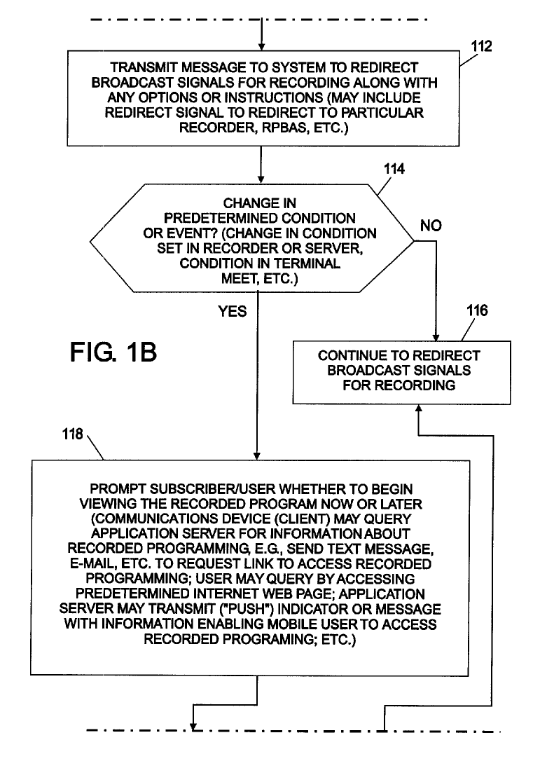

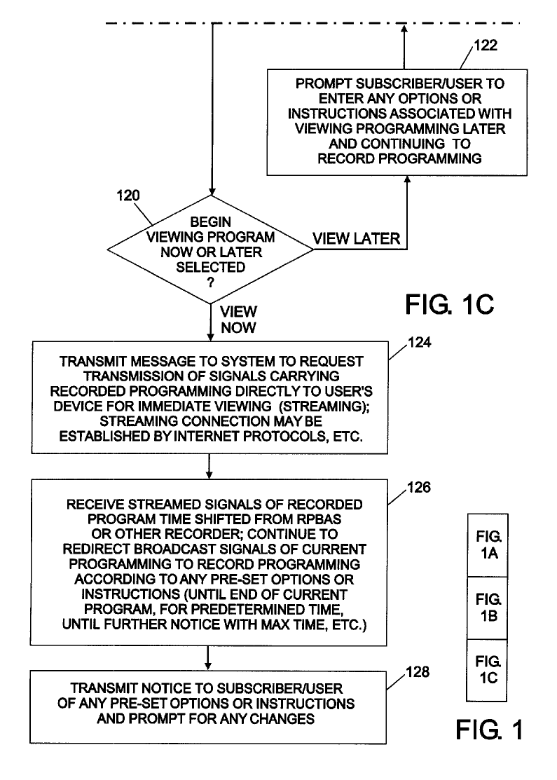

FIGS. 1A, 1B and 1C (collectively FIG. 1) are a flow chart of an example of a method 100 for redirecting broadcast signals for recording in accordance with an embodiment of the present invention. The exemplary operations and functions illustrated in method 100 may be performed by a communications device or partly by a communications device, communications system or network, mobile television provider or the like and partly by the communications device or any combination thereof.

In block 102, occurrence of a predetermined condition or event may be detected. The predetermined condition or event may be the communications device being powered-off by the user. The predetermined condition or event may also be detecting the device power source being low before being fully dissipated, the communications device receiving a voice call or other communication or some other condition or event that may hinder the user watching any programming carried by broadcast signals being received by the communications device or mobile TV device associated with or coupled to the communications device.

In block 104, a message or signal may be automatically generated and transmitted by the communications device to a communications system or network to redirect the broadcast signals to record the programming being carried by the broadcast signals. The communications system or network may be a mobile radio access network (RAN) or similar network or system. In another embodiment of the present invention, the user or subscriber may be prompted before transmitting the message whether the user desired to have the broadcast signals redirected for recording. The user may be prompted by an audio alert, visual alert or both. A tone may be provided with a text message on a display of the communications device before sending the redirect signal or message. Any prompts associated with the invention may be presented and responded to via an interactive voice feature, a graphical user interface (GUI) presented on the display of the communications device or the like. An option may be pre-selected by the user to automatically transmit the redirect message or prompt the user first. As used herein, redirecting the broadcast signals may be defined as also directing or channeling the broadcast signals, that are currently being broadcasted by the mobile TV system to other subscribers, to a device or system that can record and play back the recorded programming carried by the broadcast signals, such as a record playback application server (RPBAS) or the like.

There may be other pre-set or pre-selected options associated with redirecting the broadcast signals and recording the programming carried by the broadcast signals. For example, the broadcast signals may be redirected to an application server, record play back application server (RPBAS) or other recorder in the mobile communications network, in the broadcast network, to a third party provider's recorder or RPBAS, or to a recorder or recording system in a network on the user's premises. The redirection of the broadcast signals for recording may be accomplished by using Internet protocols such as those specified in the Internet Protocol (IP) Multimedia Subsystem (IMS) associated with releases 5 and 6 of the Third Generation Partnership Project (3GPP) standards or the like. As described in more detail herein, there may also be options selected or entered associated with a duration for redirecting the signals or for recording the programming.

In block 106, a determination may be made whether redirecting the broadcast signals for recording has been selected or authorized. If not selected in block 104 or not pre-set to automatically generate and transmit the redirect message, the method 100 may advance to block 108. In block 108, a signal or message to redirect the broadcast signals for recording will not be sent to the system or network.

If redirecting the broadcast signals for recording programming is selected or pre-set in block 104, the method 100 may advance to block 110. In block 110, the user may be prompted to enter any instructions or to select any options associated with redirecting the broadcast signals or recording the programming. For example the signals may be redirected or the programming recorded for a predetermined or pre-set time period, for the duration that the communications device is powered-off, for the duration of a voice call, until the end of the current program or other options or instructions. Similar to that previously discussed, the user may provide instructions or select options to redirect the broadcast signals to record the programming using a RPBAS or other recorder in the mobile communications network or in the broadcast network, to a third party recorder or RPBAS or to the user's or subscriber's recorder or system. The options or instructions may be pre-set or pre-defined or the user may be prompted to select the options by an interactive voice system or graphical user interface (GUI) presented on a display of the communications device or a combination of these features.

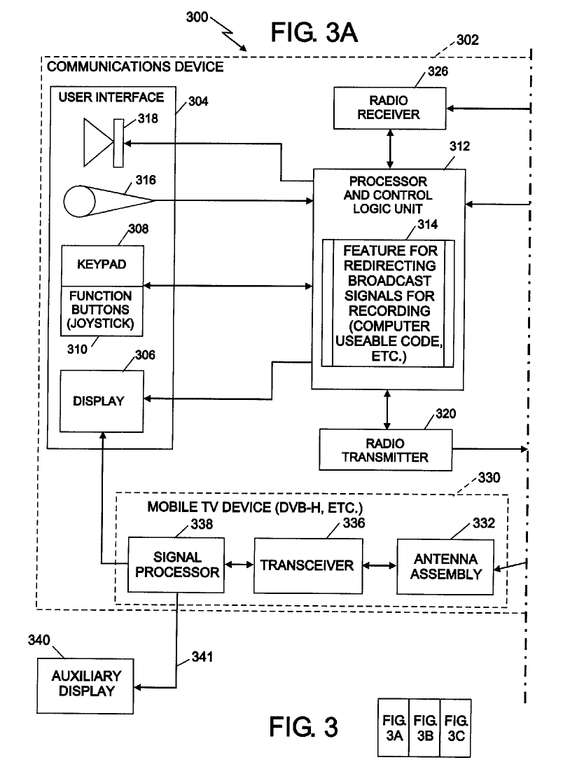

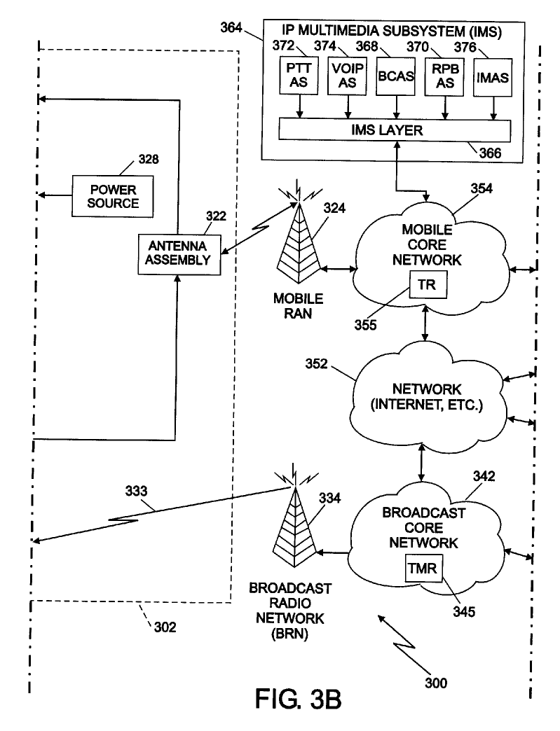

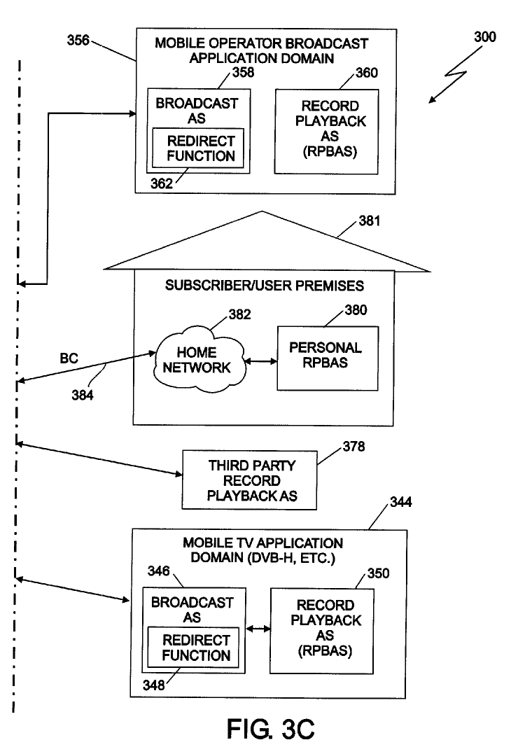

In block 112, the message or signal may be transmitted to the system or network to redirect the broadcast signals along with any options or instructions. An example of a system and means for redirecting the broadcast signals for recording the programming carried by the signals is illustrated and described with reference to FIG. 3 below.

In block 114, a determination may be made whether there has been a change in the predetermined condition or event that resulted in the broadcast signals being redirected for recording the programming. For example, a determination may be made whether a condition set in the recorder or application server during the recording initiation has been met, e.g., whether a requested recording interval has expired. Alternately, a determination may be made whether a condition in the terminal or communications device has been met, e.g., the user has selected to end a recording that was initiated as an unspecified interval. If there has been no change in the condition or event that resulted in redirecting the broadcast signals, the broadcast signals may continue to be redirected in block 116. If there has been a change in the condition or event, the method 100 may advance to block 118.

In block 118, the user may be prompted whether to begin viewing the recorded program now or at a later time. In one embodiment of the present invention, the communications device or client may query an application server or the like for information about the recorded programming, such as sending a text message, email or other form of messaging to request a link to access the recorded programming in response to a change in the predetermined condition or event. Alternately, the user may query by accessing a pre-determined Internet web page through which means to access the recorded programming is provided (e.g. web links). In another embodiment of the present invention, the application server or the like may transmit (“push”) an indicator or message to the communications device or client with information enabling the mobile user to access the recorded programming. For instance, the indicator or message may be a text message, e-mail or the like containing a link to a web page with the recorded programming. These are examples of ways the mobile user may notify a system when there is a change in the predetermined condition or event and the system may provide an indicator or message with information for accessing the recorded programming. There are also other means that exploit other communication features and capabilities of the mobile communications device and system.

In block 120, a determination may be made whether the user selected to view the program now or later. If the user selected to view the recorded programming later, the method 100 may advance to block 122. In block 122, the user may be prompted to enter any options or instructions associated with viewing the programming later and continuing to record the programming. Similar to that previously described, any prompts associated with the invention may be presented and responded to via an interactive voice feature, a GUI presented on the display of the communications device or the like. The method 100 may then advance to block 116 and the broadcast signals may continue to be redirected for recording the programming carried by the signals.

If the user selects to begin viewing the recorded programming now in block 120, the method 100 may advance to block 124. In block 124, a message or signal may be transmitted to the system or network to request transmission of signals carrying the recorded programming directly from the RPBAS or recorder directly to the user's device for immediate viewing. This direct transmission for immediate viewing is commonly known as “streaming”. The streaming connection may be setup or established by Internet protocols and methods such as those specified in the Internet Protocol (IP) multimedia subsystem (IMS) associated with releases 5 and 6 of 3GPP standards. The streamed signals may be transmitted to the communications device via the mobile RAN and core network.

In block 126, streamed signals of the recorded programming may be received time shifted from the recorder. Contemporaneous broadcast signals of the current or ongoing programming may continue to be redirected to record the ongoing programming according to any options or instructions. For example, if instructions are to redirect the broadcast signals and record the programming until an end of a current program, the system or network may detect completion of the current program before discontinuing to redirect the contemporaneous broadcast signals to the RPBAS or other recorder. In this manner, the user may be able to view a complete program time shifted for the duration of the predetermined condition or event, such as the communications device being shut-off or used for other purposes until the user elects to view the recorded program.

In block 128, a notice may be transmitted to the subscriber or user with regard to any pre-set options or instructions regarding continuing to redirect the broadcast signals and recording the programming, such as until the end of the current program, for a predetermined time, until further notice with a maximum time or the like. The user may also be prompted for any changes to the pre-set options or instructions.

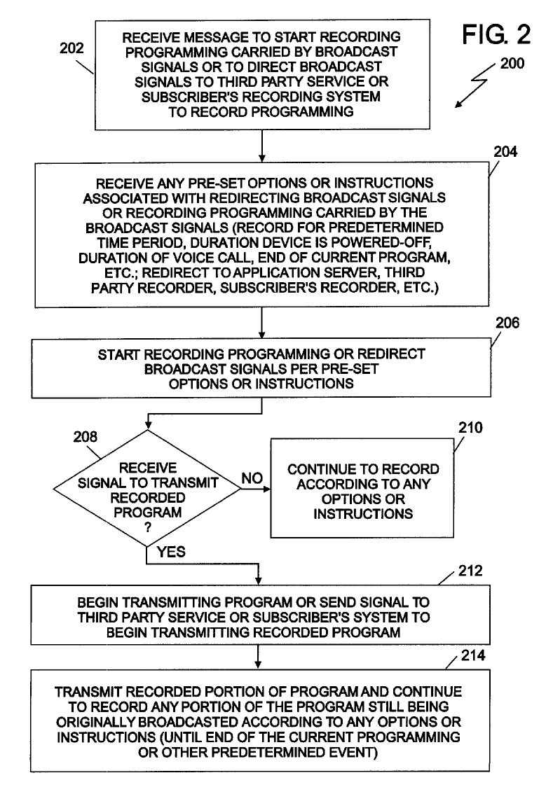

FIG. 2 is a flow chart of an example of a method 200 for redirecting broadcast signals for recording in accordance with another embodiment of the present invention. The exemplary operations or functions illustrated in method 200 may be performed by a communications system, network or mobile television provider or the like or partly by a communications network, system, mobile television provider or the like and partly by a communications device or any combination thereof.

In block 202, a message to start recording programming carried by the broadcast signals may be received. The message may also instruct to direct the broadcast signals to a RPBAS associated with the broadcast network, the mobile network, or a third party service, or alternately to a subscriber's recording system to record the programming.

In block 204, any pre-set options or instructions associated with redirecting the broadcast signals or recording the programming carried by the broadcast signals may be received. Similar to that previously discussed, examples of the pre-set or pre-defined options or instructions may include: recording the programming carried by the broadcast signals for a predetermined time period; record the programming for the duration that the communications device is powered-off, or duration of a voice call or other communications; record the programming until the end of a current program; recording the programming until further notice with a maximum time; or similar instructions or options. The pre-set options or instructions may also redirect the broadcast signals to an application server or recorder in the mobile communications network, in the broadcast network, to a third party provider's recorder, or to a recorder or recording system in a network on the user's premises. In block 206, recording the programming may begin or the broadcast signals may be redirected to another recorder or system per any options or instructions. An example of a system and means for redirecting the broadcast signals and recording the programming carried by the broadcast signals is illustrated and described with reference to FIG. 3.

In block 208, a determination may be made whether a signal to transmit broadcast signals carrying the recorded programming may have been received. If a signal or message to transmit signals of the recorded programming has not been received, the programming may continue to be recorded according to any options or instructions in block 210.

If a signal to transmit the recorded program or signals carrying the recorded program has been received, the method 200 may advance to block 212. In block 212, the recorded program or programming may be transmitted. If a third party service or subscriber system recorded the programming, a message or signal may be sent to the third party service or subscriber system to begin transmitting the recorded programming.

In block 214, the recorded portion of the programming or program may be transmitted to the communications device or mobile TV device. Any of the program still being originally broadcasted or carried by contemporaneous broadcast signals may continue to be recorded according to any options or instructions. For example the programming carried by contemporaneous broadcast signals may continue to be recorded until the end of the current programming or other predetermined event that may have been selected as an option or provided in instructions.

FIGS. 3A, 3B and 3C (collectively FIG. 3) is a block schematic diagram of an exemplary system 300 and communications device 302 for redirecting broadcast signals for recording programming carried by the signals in accordance with an embodiment of the present invention. The system 300 may be adapted to deliver broadcast content to a mobile device, such as device 302 or the like, by various means, while enabling bidirectional communication for the purpose of redirecting broadcast signals for recording and subsequent viewing according to user instructions. The communications device 302 may be a cordless telephone, cellular telephone, personal digital assistant (PDA), communicator, computer device or the like and is not unique to any particular communications standard, such as Advanced Mobile Phone Service (AMPS), Digital Advanced Mobile Phone Service (D-AMPS), Global System for Mobile Communications (GSM), Code Division Multiple Access (CDMA) or the like. The design of the communications device 302 illustrated in FIG. 3 is for purposes of explaining the present invention and the present invention is not limited to any particular design.

The communications device 302 may include an operator or user interface 304 to facilitate controlling operation of the communications device 302 including initiating and conducting phone calls and other communications. The user interface 304 may include a display 306 to provide visual signals to a subscriber or user as to the status and operation of the communications device 302. The display 306 may be a liquid crystal display (LCD) or the like capable of presenting color images. The display 306 may provide information to a user or operator in the form of images, text, numerals, characters, a graphical user interface (GUI) and the like. The display 306 may also be used to present programming carried by the broadcast signals described with respect to methods 100 and 200 of FIGS. 1 and 2, respectively.

The user interface 304 may also include a keypad 308 and function keys or buttons 310 including a pointing device, such as a joystick or the like. The keypad 308, function buttons and joystick 310 permit the user to communicate commands to the communications device 302 to dial phone numbers, initiate and terminate calls, establish other communications, such as access to a mobile TV provider, the Internet, send and receive email, text messages and the like. The keypad 308, function buttons and joystick 310 may also be used to control other operations of the communications device 302 including selection of broadcast channels for viewing and playback control of recorded content.

The display 306, keypad 308, and function buttons 310 may be coupled to a main processor and control logic unit 312. The main processor and control logic unit 312 may be a microprocessor or the like. The main processor and logic unit 312 may include a feature 314 for redirecting broadcast signals for recording programming. The functions and operations described with respect to a communications device in method 100 of FIG. 1 and method 200 of FIG. 2 may be embodied in the feature 314 for redirecting broadcast signals. The redirecting broadcast signals feature 314 may be embodied in hardware, firmware, software (data structures) or combinations thereof. The main processor and logic unit 312 may also include other data structures, software programs, computer applications and the like to encode and decode control signals; perform communication procedures and other functions as described herein.

The user interface 304 may also include a microphone 316 and a speaker 318. The microphone 316 may receive audio or acoustic signals from a user or from another acoustic source. The microphone 316 may convert the audio or acoustic signals to electrical signals. The microphone 316 may be connected to the main processor and logic unit 312 wherein the main processor and logic unit 312 may convert the electrical signals to baseband communication signals. The main processor and control logic unit 312 may be connected to a radio transmitter 320 that may convert baseband signals from the main processor and control logic unit 312 to radio frequency (RF) signals. The radio transmitter 320 may be connected to an antenna assembly 322 for transmission of the RF signals to a communication medium or system, such as a mobile radio access network (RAN) 324 or the like.

The antenna assembly 322 may receive RF signals over the air and transfer the RF signals to a radio receiver 326. The radio receiver 326 may convert the RF signals to baseband signals. The baseband signals may be applied to the main processor and control logic unit 312 which may convert the baseband signals to electrical signals. The processor and control unit 312 may send the electrical signals to the speaker 318 which may convert the electrical signals to audio signals that can be understood by the user.

A power source 328 may be connected to the main processor and control logic unit 312 to provide power for operation of the communications device 302. The power source 328 may be a rechargeable battery or the like. Processor 312 or redirecting feature 314 may monitor status of the power source 328 for redirecting the broadcast signals in accordance with the invention.

The communications device 302 may also include a mobile TV device 330. The mobile TV device 330 may be a DVB-H type device or the like. The mobile TV broadcast may be carried by mobile communications signals, such as a Multimedia Broadcast Multicast System (MBMS) broadcast feature in a mobile network. In this type system, the DVB-H receiver may be optional in the mobile device 330, but some mobile devices may have both MBMS and DVB-H capability in order to provide the widest possible mobile-TV coverage since technology choice may vary by system operator and/or region. The mobile TV device 330 may be integrally formed as part of the communications device 302 or may be a separate unit that may be connected and operate in association with the communications device 302. The mobile TV device 330 may include an antenna assembly 332 for receiving broadcast signals 333 of programming from a mobile TV broadcast network, broadcast radio network (BRN) 334 or the like. A transceiver 336 may be coupled to the antenna assembly 332 to receive the broadcast signals 333. A signal processor 338 may receive the broadcast signals 333 from the transceiver 336 and convert the signals to a format for presentation on the display 306 of the communications device 302 or on an auxiliary display 340. Typically, the auxiliary display 340 may be much larger and include more pixels than the display 306 of the communications device 302 and provide better picture quality. The auxiliary display 340 may also include an audio system (not shown) for better sound quality than the speaker 318 associated with the communications device 302. A connection 341 to the auxiliary display 340 may be a hardwired connection or a wireless connection via Bluetooth, Wireless Local Area Network (WLAN) or the like.

The broadcast radio network (BRN) 334 may be connected to a broadcast core network (BCN) 342 or the like. The broadcast core network 342 may transport the mobile TV or DVB-H broadcast data to the BRN 334 for broadcasting to communications devices or mobile TV devices, such as communications device 302 and mobile TV device 330. The BRN 334 may include a transmitter 345 to transmit the broadcast signals.

The BCN 342 may be connected to a mobile TV provider or mobile TV application domain 344. The mobile TV application domain 344 may originate programming for broadcasting to communications devices 302 or mobile TV devices 330 via the BCN 342 and BRN 334. The mobile TV application domain 344 may include a broadcast application server (BCAS) 346. The broadcast application server 346 may include a feature 348 for redirecting broadcast signals for recording programming. At least some of the functions and operations described with respect to the methods 100 and 200 of FIGS. 1 and 2 may be embodied in the broadcast application server 346 and the feature 348 for redirecting broadcast signals. The redirecting feature 348 may be embodied in hardware, firmware, software (data structures) or combinations thereof.

The mobile TV application domain 344 may also include a recorder or record playback application server (RPBAS) 350 or the like. The record playback application server 350 may include a digital video recorder (DVR) or the like that may be adapted to continue to record current programming carried by contemporaneous broadcast signals while playing back recorded programming from previously broadcasted signals similar to that described with respect to block 214 of method 200 (FIG. 2).

The BCN 342 may be connected to the Internet 352 or other private network that may utilize Internet protocol (IP) or the like. The BCN 342 and the mobile TV application domain 344 may receive and transmit signals or messages to control the redirecting of broadcast signals for recording programming carried by the signals via the Internet 352. Messages and signals to control the playback of recorded programming may also be transmitted and received via the Internet 352 similar to that described with respect to methods 100 and 200 of FIGS. 1 and 2.

The mobile RAN 324 may be coupled to a mobile core network (CN) 354. The mobile RAN 324 or the mobile CN 354 may include a transceiver 355 to transmit streamed signals carrying the recorded programming to the communications device 302 or mobile TV device 330. In one embodiment of the present invention, the mobile CN 342 may be connected to the Internet 352 or other network and to a mobile operator broadcast application domain 356. The broadcast signals may be redirected via the Internet 352 from the BCN 342 to the mobile operator broadcast application domain 356 for recording programming. The mobile operator broadcast application domain 344 may include a broadcast application server 358 and a recorder or record playback application server (RPBAS) 360 or the like for recording the programming carried by the broadcast signals. The broadcast application server 358 may include a redirect feature 362 that may embody some of the functions described with respect to methods 100 and 200 of FIGS. 1 and 2, respectively.

In another embodiment of the present invention, an IP multimedia subsystem (IMS) 364 may be provided. The IMS 364 may be described as a mobile application network domain that may be coupled to the mobile CN 354 via an IMS layer 366, which provides common services and methods for associated application servers 368-376 to communicate with mobile devices in the network. The IMS 364 may embody various elements and functions. For example, the IMS 364 may include a broadcast application server (BCAS) 368 and record playback application server (RPBAS) 370 to receive redirected broadcast signals and perform recording and playback operations similar to those described with respect to methods 100 and 200 of FIGS. 1 and 2, respectively. Other examples of application servers that may be included in the IMS 364 may be a push-to-talk application server 372 for half-duplex voice communications, a voice-over-IP application server 374 for full-duplex voice communications, and an instant messaging application server (IMAS) 376.

In another embodiment of the present invention, as discussed with respect to methods 100 and 200, a third-party provider or third-party recorder or RPBAS 378 may be present and selected to receive the redirected broadcast signals and to record the programming carried by the redirected broadcast signals. The third-party RPBAS 378 may be connected to the Internet 352 to receive the redirected broadcast signals, play back the recorded programming and send and receive control signals or messages with respect to recording and play back.

Also, similar to that discussed with respect to methods 100 and 200 of FIGS. 1 and 2, respectively, a subscriber's or user's recorder system or personal RPBAS 380 at a subscriber's premises 381 may be selected to receive the redirected broadcast signals. The subscriber's personal RPBAS 354 may be connected to the Internet 352 or other network via the subscriber's home network 382 and a broadband connection (BC) 384 or the like. Accordingly, the subscriber's RPBAS 380 may receive the transmitted broadcast signals, playback the recorded programming and send and receive control signals similar to those functions described with respect to methods 100 and 200 via the Internet connection 352.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for redirecting broadcast signals for recording, comprising:
detecting occurrence of a predetermined condition or event;
transmitting a message to redirect the broadcast signals for recording programming carried by the broadcast signals; and
transmitting any options or instructions associated with redirecting the broadcast signals or recording the programming.

2. The method of claim 1, further comprising:
prompting a user whether to redirect the broadcast signals before transmitting the message; and
transmitting the message and any options or instructions to a system to redirect the broadcast signals in response to the user affirming redirection of the broadcast signals for recording.

3. The method of claim 1, further comprising automatically transmitting the message to redirect the broadcast signals in response to detecting occurrence of the predetermined condition or event.

4. The method of claim 1, wherein the predetermined condition or event comprises one of powering-off a communications device receiving the broadcast signals; a low power source condition in the communications device receiving the broadcast signals; the communications device receiving a voice call; or the communications device receiving another communication that hinders a user from viewing programming carried by the broadcast signals.

5. The method of claim 1, wherein the options or instructions comprise at least one of:
redirecting the broadcast signals for a predetermined time period;
redirecting the broadcast signals for a duration that a communications device receiving the broadcast signals is powered-off;
redirecting the broadcast signals for a duration of a voice call or other communication received by the communications device;
recording programming carried by the broadcast signals until an end of a currently broadcasted program; and
continuing to record until further notice or until a pre-set maximum time duration.

6. The method of claim 1, wherein transmitting the message to redirect the broadcast signals comprises transmitting a redirect signal to redirect the broadcast signals to one of a group comprising a recorder or recording function in the communications network, a recorder or recording function in the broadcast network, a third-party recorder or recording function, and the user's own recorder or recording function.

7. The method of claim 1, further comprising prompting a user whether to begin viewing a recorded program now or later in response to a change in the predetermined condition or event.

8. The method of claim 7, further comprising prompting the user to enter any options or instructions associated with viewing the recorded program later and continuing to record the broadcast signals.

9. The method of claim 7, further comprising:
receiving signals of a recorded portion of the program in response to selecting to begin viewing the program; and
continuing to redirect the broadcast signals to record the programming according to any options or instructions.

10. The method of claim 1, further comprising sending a query for information about the recorded programming.

11. The method of claim 1, further comprising requesting a link to access the recorded programming.

12. The method of claim 1, further comprising providing a predetermined Internet web page accessible by the user to access the recorded programming.

13. The method of claim 1, further comprising transmitting an indicator including information enabling access to the recorded programming.

14. The method of claim 13, wherein transmitting the indicator comprises transmitting one of a text message, an e-mail message or another communication including a link to a web page for access to the recorded programming.

15. A system for performing the method of claim 1.

16. A computer-readable medium having computer-executable instructions for performing the method of claim 1.

17. A method for redirecting broadcast signals, comprising:
recording programming in response to receiving a message to start recording programming carried by broadcast signals and according to any options or instructions, wherein the message to start recording programming being sent in response to detecting occurrence of a predetermined condition or event;
transmitting signals of the recorded programming in response to receiving a signal to transmit the recorded programming, wherein the signal to transmit the recorded programming being sent in response to a change in the predetermined condition or event; and
continuing to record any portions of the programming according to any options or instructions.

18. The method of claim 17, wherein the predetermined condition or event comprises one of powering-off a communications device receiving the broadcast signals; a low power source condition in the communications device receiving the broadcast signals; the communications device receiving a voice call; or the communications device receiving another communication that hinders a user from viewing programming carried by the broadcast signals.

19. The method of claim 17, further comprising redirecting the broadcast signals to one of a third party recording service or a subscriber's recording system in response to any instructions to do so.

20. The method of claim 17, wherein any options or instructions comprise at least one of:
recording the programming carried by the broadcast signals for a predetermined time period;
recording the programming for a duration that a communications device receiving the broadcast signals is powered-off;
recording the programming for a duration of a voice call or other communication received by the communications device;
recording the programming carried by the broadcast signals until an end of a currently broadcasted program; and
continuing to record the programming until further notice or expiration of a maximum time period.

21. A system for redirecting broadcast signals for recording, comprising:
a recorder to record programming in response to receiving a message to start recording programming carried by broadcast signals and to record programming according to any options or instructions, wherein the message to start recording programming being sent by a communications device in response to detecting occurrence of a predetermined condition or event; and
a transceiver to broadcast signals of the recorded programming in response to receiving a signal to transmit the recorded programming, wherein the signal to transmit the recorded programming being sent by the communications device in response to a change in the predetermined condition or event.

22. The system of claim 21, wherein the recorder continues to record any portions of the programming according to any options or instructions.

23. The system of claim 21, wherein any options or instructions comprise at least one of:
recording the programming carried by the broadcast signals for a predetermined time period;
recording the programming for a duration that the communications device receiving the broadcast signals is powered-off;
recording the programming for a duration of a voice call or other communication received by the communications device;
recording the programming carried by the broadcast signals until an end of a currently broadcasted program; and
continuing to record programming until further notice or until a maximum duration.

24. The system of claim 21, wherein the recorder is provided by one of a mobile operator, a mobile . TV service provider, a third party provider or a subscriber's recorder system.

25. The system of claim 21, further comprising a web page accessing the recorded programming.

26. The system of claim 21, further comprising means for transmitting an indicator including information enabling access to the recorded programming.

27. The system of claim 26, further comprising means for transmitting one of a text message, an e-mail message or another communication including a link to a web page for access to the recorded programming.

28. A communications device, comprising:
a feature adapted to generate a message to redirect broadcast signals for recording programming carried by the broadcast signals in response to detecting occurrence of a predetermined condition or event; and
a transmitter to transmit the message to redirect the broadcast signals and any options or instructions associated with redirecting the broadcast signals or recording the programming.

29. The communications device of claim 28, further comprising a mobile TV device to present the programming carried by the broadcast signals, wherein the mobile TV device is integrated into the communications device or the mobile TV device is a separate device connectable to the communications device.

30. The communications device of claim 29, further comprising an auxiliary display connectable to the mobile TV device to present the programming.

31. The communications device of claim 28, further comprising means for detecting occurrence of the predetermined condition or event, wherein the predetermined condition or event comprises one of powering-off the communications device receiving the broadcast signals; a low power source condition in the communications device receiving the broadcast signals; the communications device receiving a voice call; or the communications device receiving another communication that hinders a user from viewing programming carried by the broadcast signals.

32. A computer program product for redirecting signals for recording, the computer program product comprising:
a computer readable medium having computer usable program code embodied therein, the computer readable medium comprising:
computer usable program code configured to detect occurrence of a predetermined condition or event;
computer usable program code configured to transmit a message to redirect the broadcast signals for recording programming carried by the broadcast signals; and
computer usable program code configured to transmit any options or instructions associated with redirecting the broadcast signals or recording the programming.

33. The computer program product of claim 32, further comprising:
computer usable program code configured to prompt a user whether to redirect the broadcast signals before transmitting the message; and
computer usable program code configured to transmit the message and any options or instructions to a system to redirect the broadcast signals in response to the user affirming redirection of the broadcast signals for recording.

34. The computer program product of claim 32, further comprising computer usable program code configured to detect powering-off a communications device receiving the broadcast signals; a low power source condition in the communications device receiving the broadcast signals; the communications device receiving a voice call; or the communications device receiving another communication that hinders a user from viewing programming carried by the broadcast signals.

35. The computer program product of claim 32, further comprising computer usable program code configured to prompt a user whether to begin viewing a recorded program now or later in response to a change in the predetermined condition or event.
